(19) United States
(12) Patent Application Publication
(10) Pub. No.: US 2024/0412581 A1
(43) Pub. Date: Dec. 12, 2024

(54) SYSTEMS AND METHODS FOR AUTOMATED DECISION CAPTURING AND TRACKING

(71) Applicant: STICKS AND STONES IP LLC, Tacoma, WA (US)

(72) Inventors: Dean Michael Graziano, Mill Creek, WA (US); James Thurman Webber, Tacoma, WA (US)

(21) Appl. No.: 18/698,308

(22) PCT Filed: Oct. 3, 2022
(86) PCT No.: PCT/US2022/045568

§ 371 Date: Apr. 3, 2024

Related U.S. Application Data
(60) Provisional application No. 63/252,015, filed on Oct. 4, 2021.

(51) Int. Cl. G07C 13/00

(52) U.S. Cl. CPC G07C 13/00

(57) ABSTRACT

Described is implementing a decision capturing and tracking process, which may be used for any type of decision capturing process, such as a voting process or other process that captures and subsequently counts decisions made by individuals. Provided is a streamlined, convenient, and secure method for implementing a voting system that overcomes many of the challenges present in existing systems, while significantly improving the functionality of computer systems by reducing complexity, storage and processing requirements. This is achieved by using the position of an individual's body as the mechanism for capturing the individual's decision, which allows for an improved process. A system is provided that automatically captures a plurality of an individual's decisions as the individual continuously travels (e.g., walks, rolls, rides, drives) along a path and makes choices along the way. The captured decisions may then be used for counting, tracking, auditing, smart contracts, tokens, currencies, or other uses.

### BACKGROUND

### Technical Field

The present application relates to decision-capturing and tracking systems, for example, voting systems usable to obtain and track votes for a plurality of individuals.

### Description of the Related Art

Recently, there has been a substantial increase in the number of governments throughout the world that have adopted a model of government in which qualified and registered voters elect a variety of local, state, and federal officials to particular offices and decide various other issues. Conventionally, elections have been conducted utilizing paper ballots which are issued to registered voters at particular polling places. This requires the physical attendance of the voter at a particular polling place in order to allow voting. Other jurisdictions have utilized various mail-in ballot procedures. In many jurisdictions, voter participation has been poor, perhaps largely due to the burdens of work and family which make fairly strenuous demands on the citizens, as well as the time required for individuals to cast their votes due to long lines or inefficient voting procedures. Another problem is the tremendous expense associated with conducting the elections in a manner which renders the election results substantially free from corruption and error. The goals of maximizing convenience, minimizing expense, and minimizing security risks are found in most jurisdictions. At least two other concerns also figure prominently in systems which enable democratic elections. The first is the voter's right of privacy to his or her voting decisions. The second consideration is the ease with which particular votes can be challenged and corrected without presenting risks to the security and privacy of the votes in general.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of a decision capturing and tracking system, according to one non-limiting illustrated implementation.

FIG. 2 is a flow chart for a method of operating a decision capturing and tracking system, according to one non-limiting illustrated implementation.

FIG. 3 is a top plan view of an example decision capturing and tracking system, according to one non-limiting illustrated implementation.

FIG. 4 is a top plan view of another example decision capturing and tracking system, according to one non-limiting illustrated implementation.

FIG. 5 is a schematic block diagram of a computing environment that may be used to implement a decision capturing and tracking system, according to one non-limiting illustrated implementation.

FIG. 6 is a schematic block diagram of a computer system that may be used to implement one or more functions provided by a decision capturing and tracking system, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure are directed to implementing an automated decision capturing and tracking process, which may be used for any type of decision capturing process, such as a voting process or other process that captures and counts decisions made by individuals. The embodiments discussed herein provide a streamlined, convenient, and secure method for implementing a voting system that overcomes many of the challenges present in existing systems, while significantly improving the functionality of computer systems by reducing complexity, storage and processing requirements. This is achieved by using the physical position of an individual's body as the mechanism for capturing the individual's decision, which allows for an improved process. In at least some implementations, a system may be provided that automatically captures one or a plurality (e.g., two, five, 10, 15) of an individual's decisions as the individual continuously travels (e.g., walks, rolls, rides, drives) along a path and makes choices along the way. The captured decisions may then be used for counting, tracking, auditing, or other uses.

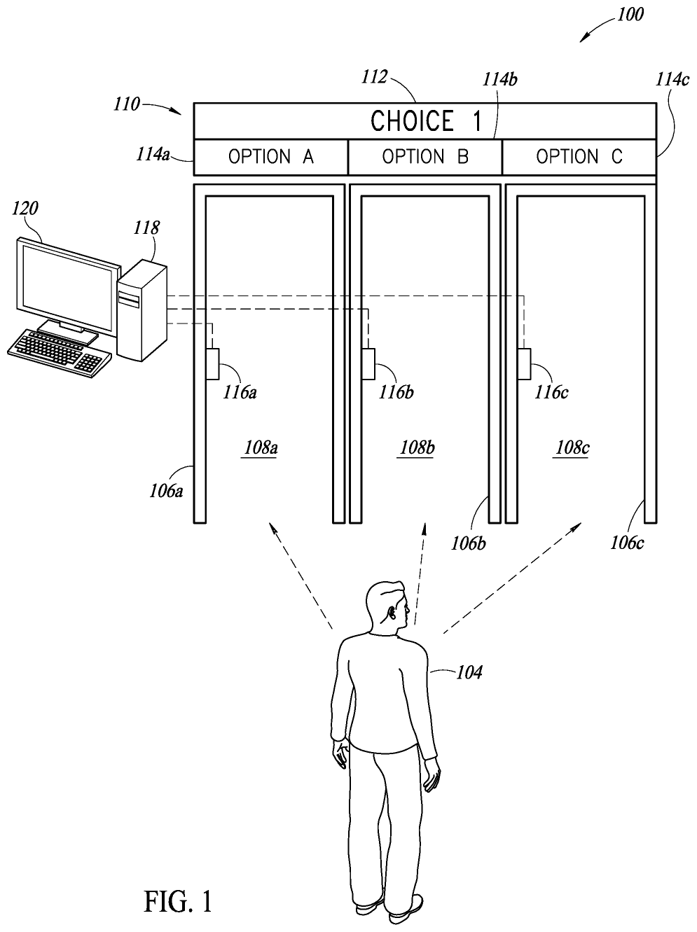

FIG. 1 is a schematic diagram of a decision capturing and tracking system 100 that may be used to implement a decision capturing and tracking process for a plurality of individuals, such as a plurality of voters, according to one non-limiting illustrated implementation. The decision capturing and tracking system 100 includes a plurality of physical pathways 108 through which individuals, such as an individual 104 shown in FIG. 1, may traverse. As an example, the physical pathways 108 may be formed by one or more structures 106 through which the individual 104 may travel through (e.g., walk through, ride through, drive through). In the non-limiting example shown in FIG. 1, the structures 106 include three structures, labeled 106a, 106b, and 106c, which provide respective physical pathways 108a, 108b, and 108c. It should be appreciated that structures 106 may provide any suitable number of physical pathways, as discussed further below. Each of the physical pathways 108 correspond to a different option that the individual may select for a choice (e.g., a candidate, an issue).

The system 100 may include an indicator 110 that provides an instruction to the individual to physically pass through one of the plurality of physical pathways 108 to select one of a plurality of selectable options that relate to a particular choice. In the illustrated example, the indicator 110 identifies a choice 112 (“Choice 1”) and three options 114a-114c (“Option A,” “Option B,” “Option C”) for the choice 112 that the individual may select by traveling through one of the corresponding pathways 108a-108c, respectively.

The system 100 may further include one or more signal detectors 116, three shown labeled 116a-116c, which may be used to detect which physical pathway of the plurality of physical pathways that the individual 104 passes through. In the illustrated example, the system 100 includes three signal detectors 116a-116c that correspond to the physical pathways 108a-108c, respectively. The signal detectors 116 may be communicatively coupled to a computing system 118 via a wired or wireless connection, which may be further coupled to one or more local or remote displays, such as a display device 120 shown in FIG. 1.

The signal detectors 116 may be used to detect or capture which pathway 108 the individual travels through. The detectors 116 may communicate such information to the computer system 118, which may increment a count of selections by the individuals 104 in a nontransitory computer memory. The computer system 118 may also record a timestamp for the time when the individual passes through each pathway 108, which may be used for auditing, verification, or other tracking purposes. In at least some implementations, the count may be displayed on the display device 120 in real-time or near real-time so that other individuals (e.g., election officials, voters, other individuals) may view the results.

In at least some implementations, the signal detectors 116 may capture unique identification information associated with the individuals 104 such that each individual may be logically associated with the selected option 114 associated with the detected physical pathway 108 in a nontransitory computer memory. As one non-limiting example, the signal detectors 116 may include machine-readable symbol readers, wherein each of the plurality of machine-readable symbol readers is physically positioned proximate a different one of the plurality of physical pathways and logically associated therewith. In the illustrated example, in operation the detectors 116 may read a machine readable symbol carried by the individual. The symbol may be on a physical object (e.g., a piece of paper, a printed ticket, a plastic card, a wrist band) or may be displayed by a device (e.g., displayed on a display of a smartphone, tablet, or wearable computer). In at least some implementations, the signal detectors 116 may include one or more of an electromagnetic signal detector (e.g., RFID, NFC), an optical signal detector (e.g., optical scanner, camera), an acoustic signal detector, a magnetic signal detector, or the like.

In the illustrated embodiment, the physical pathways 108 are shown as “doorways,” although the present disclosure is not limited to such implementation. In at least some implementations, each of the physical pathways 108 may include various other types of structures, such as a turnstile, a pair of spaced-apart sidewalls that define a physical pathway, a lane defined by or more lane indicators, etc. Further, in at least some implementations, at least some of the plurality of physical pathways are shielded from viewers by one or more privacy structures (e.g., walls, curtains, partitions) that protect the individuals' privacy during the decision capturing process.

As discussed above, one or more local or remote displays (e.g., display device 120) may be used to display one or more of an overall count of selections by the individuals, a count of one or more issues, video of individuals entering or exiting the plurality of physical pathways, or other information.

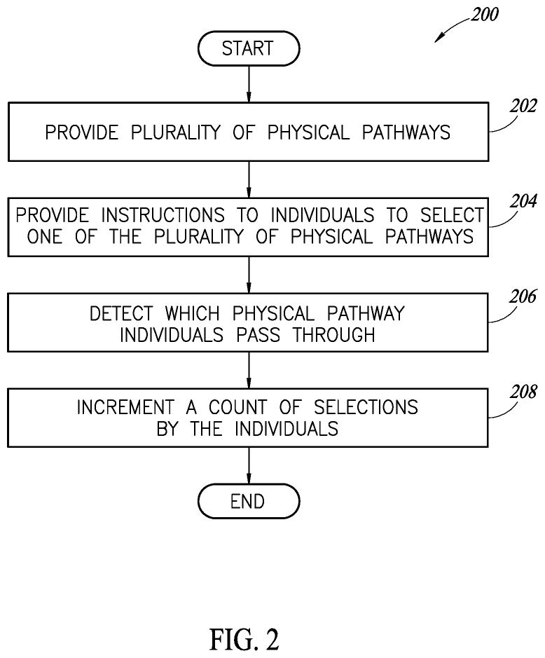

FIG. 2 is a flow chart for a method 200 of operating a decision capturing and tracking system, according to one non-limiting illustrated implementation. The method 200 may be performed by one or more systems disclosed herein, such as the decision capturing and tracking system 100 shown in FIG. 1.

The method 200 begins at 202, wherein, for each selectable option of a plurality of first selectable options, a corresponding plurality of physical pathways is provided through which individuals may traverse. Each of the plurality of physical pathways are associated with a different one of the plurality of first selectable options.

At 204, an instruction is provided to the individual to physically pass through one of the plurality of physical pathways to select one of the plurality of first selectable options. As an example, each of the pathways may be clearly labeled to indicate which choice of a plurality of selectable choices is associated with the pathway. The indicators may include signs, electronic displays, color-coded indicators, text, images, audio, video, any other type of indicator, or combinations thereof.

At 206, at least one processor detects which physical pathway of the plurality of physical pathways that the individual passed through. The system may logically associate the individual with the first selectable option that is associated with the detected physical pathway in a nontransitory computer memory. As discussed above, to detect which pathway an individual traverses, one or more signal detectors may be provides, such as the signal detectors 116 shown in FIG. 1. The signal detectors may utilize any type of technology to detect that an individual travels through a particular pathway, such as detection of a symbol (e.g., barcode, QR code, text, image), facial recognition, bio-signatures, etc.

At 208, the system may increment a count of selections by the individuals for the selectable option of the first selectable options that is associated with the detected physical pathway in a nontransitory computer memory. As discussed above, once individuals' decisions have been captured, the decisions may be counted, tracked, audited, or used for any other purpose.

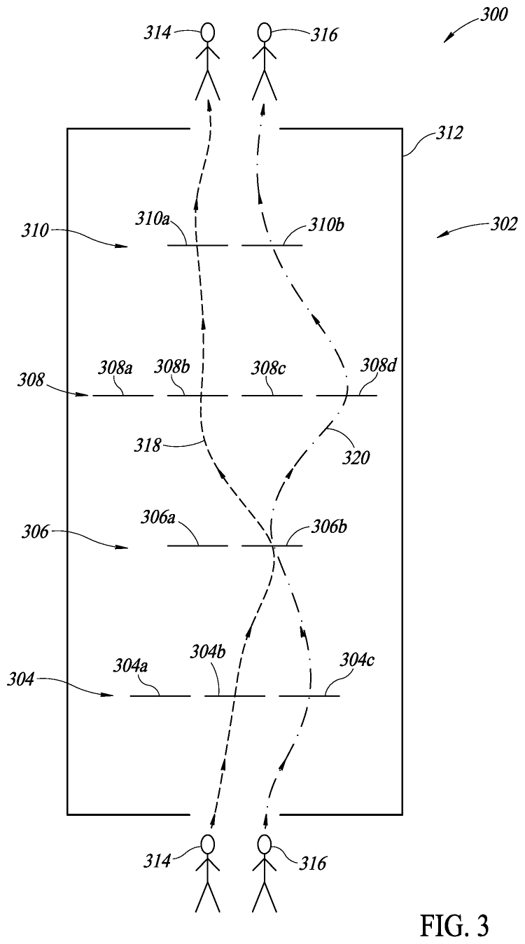

FIG. 3 is a top plan view of an example decision capturing and tracking system 300, according to one non-limiting illustrated implementation. The system 300 may be similar or identical to the system 100 of FIG. 1 in many respects. Accordingly, the system 300 may include various components of the system 100, and vice versa. The system 300 includes a layout 302 that includes structures 304, 306, 308, and 310 that are surrounded by a privacy screening structure 312. The privacy screening structure 312 may include one or more of fixed or temporary walls, partitions, curtains, or any other type of structure that provides privacy for individuals as they traverse the pathways of the layout 302. The structures 304, 306, 308 and 310 may each define a plurality of options for a particular choice. In the illustrated example, the structure 304 provides three options 304a-304c for a first choice, the structure 306 provides two options 306a-306b for a second choice, the structure 308 provides four options 308a-308d for a third choice, and the structure 310 provides two options 310a-310b for a fourth choice. As a non-limiting example, the structure 304 may correspond a choice for an elected official that includes three candidates, corresponding to options 304a-304c, whereas the structure 306 may correspond to an issue that includes a “vote yes” and a “vote no” option, corresponding to options 306a and 306b, respectively.

In operation, individuals 314 and 316 may traverse a path through the structures 304-310 to select particular options for each of the four choices. In the illustrated example, the individual 314 selects option 304b, 306b, 308b, and 310a, as indicated by the path 318 traversed by the individual 314. Similarly, the individual 316 selects option 304c, 306b, 308d, and 310b, as indicated by the path 320 traversed by the individual 316. As discussed above, the system 300 may include one or more signal detectors (e.g., symbol readers, RFID readers, NFC readers, cameras) that detect which options are selected by each individual as they traverse through the layout 302.

In practice, the layout 302 may be provided in any suitable area, such as a parking lot, gymnasium, athletic field, classroom, etc. Further, although the example provided herein refers to individuals walking through the pathways, the present disclosure is not so limited. Individuals may traverse through the pathway in any way, including walking, driving a vehicle, riding a bicycle, etc.

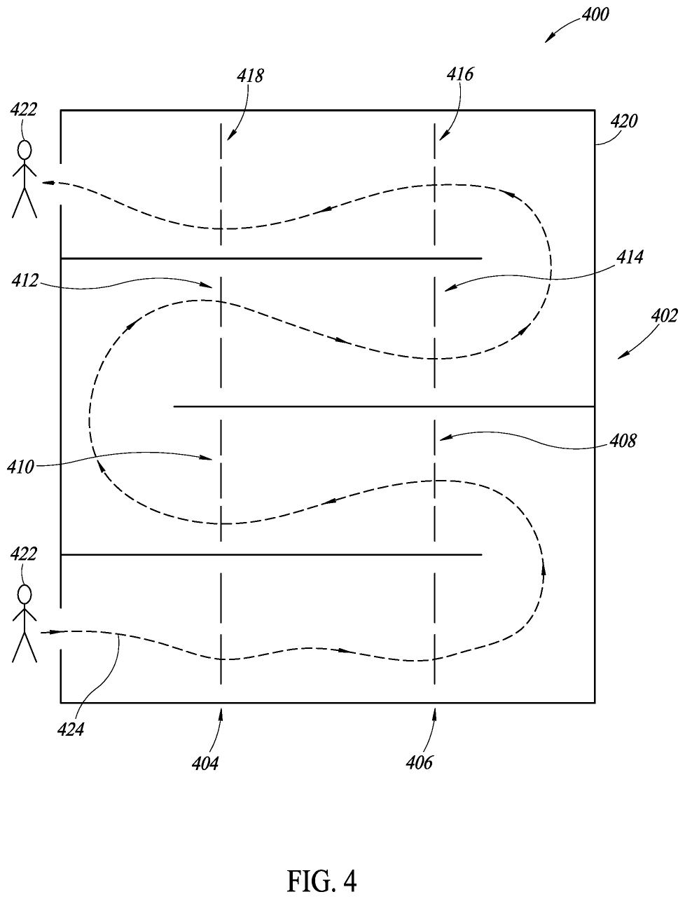

FIG. 4 is a top plan view of another example decision capturing and tracking system, according to one non-limiting illustrated implementation. The system 400 may be similar or identical to the systems 100 and 300 in many respects. Accordingly, the system 400 may include various components of the systems 100 and 300, and vice versa. The system 400 includes a layout 402 that includes structures 404, 406, 408, 410, 412, 414, 416, and 418 that are surrounded by a privacy screening structure 420. The structures 404, 406, 408, 410, 412, 414, 416, and 418 may each define a plurality of options for a particular choice. In the illustrated example, the structure 404 provides two options for a first choice, the structure 406 provides two options for a second choice, the structure 408 provides three options for a third choice, the structure 410 provides three options for a fourth choice, the structure 412 provides two options for a fifth choice, the structure 414 provides two options for a sixth choice, the structure 416 provides three options for a seventh choice, and the structure 418 provides three options for an eighth choice. As a non-limiting example, the structure 404 may correspond a choice for an elected official that includes two candidates, whereas the structure 408 may correspond to a choice for an elected official that includes three candidates.

In operation, an individual, such as the individual 422 shown in FIG. 4, may traverse a path through the structures 404-418 to select particular options for each of the eight choices. As discussed above, the system 400 may include one or more signal detectors (e.g., symbol readers, RFID readers, NFC readers, cameras) that detect which options are selected by each individual as they traverse through the layout 402. In practice, the layout 402 may be provided in any suitable area, such as a parking lot, gymnasium, athletic field, classroom, etc. Further, although the example provided herein refers to individuals walking through the pathways, the present disclosure is not so limited. Individuals may traverse through the pathway in any way, including walking, driving a vehicle, riding a bicycle, etc.

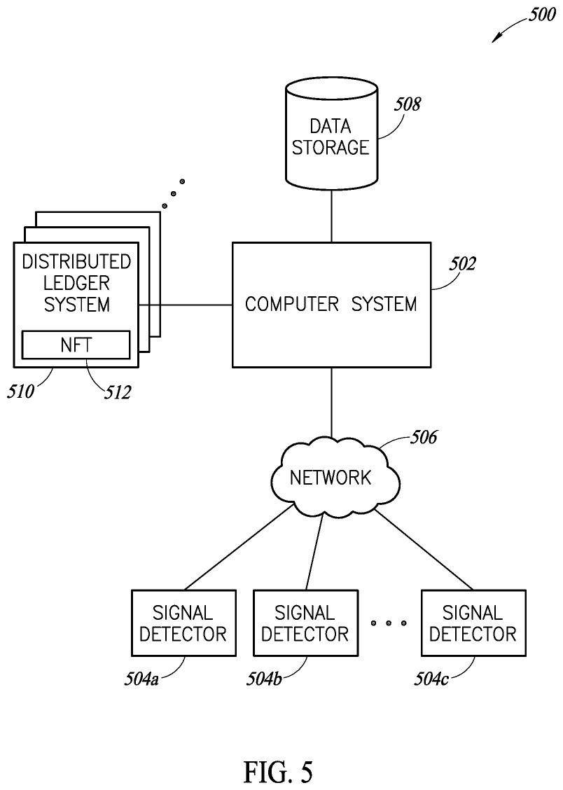

FIG. 5 shows an exemplary system architecture 500 in which the methods described herein may be implemented. The system architecture 500 may include signal detector devices 504 (three shown, labeled 504a-504c), a computer system 502, and a network 506. The network 506 serves as a medium providing a communication link between the signal detectors 504a-504c and the computer system 502. The computer system 502 may include one or more of a desktop computer, a server computer, or any other suitable computer system. The network 506 may include various types of connections, such as a wired communication link, a wireless communication link, a fiber cable, or combinations thereof.

It should be noted that the computer system 502 may be hardware or software. When the computer system 502 is server hardware, the server may be implemented as a distributed server cluster including a plurality of servers, or may be implemented as a single server. When the computer system is server software, the server may be implemented as a plurality of software packages or software modules (e.g., software or software modules for providing distributed services), or may be implemented as an individual software package or software module. This is not specifically limited herein.

It should be understood that the number of the signal detectors 504, the number of the networks 506, and the number of the computer systems 502 in FIG. 5 are only illustrative. Any number of signal detectors, networks and computer systems may be provided based on the actual requirements of a particular implementation.

The computer system 502 may include or be coupled to a data store 508, which may be used to store various information regarding a decision capturing process, as discussed elsewhere herein. Such information may be used for determining or tracking results, auditing, verification, etc.

The computer system 502 may additionally or alternatively be coupled to a distributed ledger system (e.g., blockchain) 510 to provide a highly secure, decentralized, anonymized, yet auditable chain of record to record and report decisions (e.g., votes) and prevent many types of fraud (e.g., fraud in elections). Further, in at least some implementations, individuals' one or more decisions may be stored as non-fungible tokens (NFTs), which allows individuals decisions (e.g., votes) to be provably unique. The decision or vote can be in any form, such as a printed/signed document, an ID, a fingerprint or other biometric signature, a video, etc. Any of these records of decisions can be rendered as NFTs.

The NFT is representative of a user's choice (e.g., vote), and may not simply reflect that the user participated (e.g., voted). In at least some implementations, the system may create a “token” that is presented to the user, such as a coin against a currency. In at least some instances, a Proof of Attendance Protocol (POAP) smart contract or token may be provided to each user for each choice they make (e.g., each decision point) or for their overall participation in an event (e.g., election). For example, if there are 18 total choices (e.g., candidates, issues), and the user travels through all of them, then the user would receive 18 “tokens” or “coins” that are based on a particular currency or coin. This coin or currency may have value similar to a stock, with price fluctuations based on the real value of participating in their own democracy and other democracies around the world.

Each POAP may be a digital record held by collectors as digital proof that they attended, or participated in, a physical or virtual event, such as an election. As discussed above, the POAP can double as a token qualifying its collector for potential future utility. In at least some implementations, any country or jurisdiction that implements the full capabilities may have to “mine,” the more cost items that vote/participate the more “mining” (scarcity). Further, the system may be implemented on a public blockchain, a private blockchain, or any combination thereof.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for implementing and tracking a decision-capturing process among individuals. The method also includes for each selectable option of a plurality of first selectable options, providing a corresponding plurality of physical pathways through which individuals may traverse, each of the plurality of physical pathways being associated with a different one of the plurality of first selectable options. The method also includes, for each of the individuals, providing an instruction to the individual to physically pass through one of the plurality of physical pathways to select one of the plurality of first selectable options. The method also includes detecting, by at least one processor, which physical pathway of the plurality of physical pathways that the individual passed through. The method also includes incrementing, by the at least one processor, a count of selections by the individuals for the selectable option of the first selectable options that is associated with the detected physical pathway in a nontransitory computer memory. Other embodiments of this aspect include corresponding computer systems, apparatus, and computer programs recorded on one or more computer storage devices, each configured to perform the actions of the methods.

Implementations may include one or more of the following features. The method may include logically associating, by the at least one processor, the individual with the first selectable option that is associated with the detected physical pathway in a nontransitory computer memory. Detecting which physical pathway of the plurality of physical pathways that the individual passed through may include: providing a plurality of machine-readable symbol readers, each of the plurality of machine-readable symbol readers physically positioned proximate a different one of the plurality of physical pathways and logically associated therewith; and reading, by the one of the plurality of machine-readable symbol readers associated with the physical pathway that the individual passed through, a machine readable symbol carried by the individual. Detecting which physical pathway of the plurality of physical pathways that the individual passed through may include: providing a plurality of signal detectors, each of the plurality of signal detectors physically positioned proximate a different one of the plurality of physical pathways and logically associated therewith; and detecting a signal by the one of the plurality of signal detectors associated with the physical pathway that the individual passed through. Each of the plurality of signal detectors may include an electromagnetic signal detector, an optical signal detector, an acoustic signal detector, or a magnetic signal detector. Each of the plurality of physical pathways may include: a turnstile, a pair of spaced-apart sidewalls that define the physical pathway, a doorway, or a lane defined by or more lane indicators. In at least some implementations, at least some of the plurality of physical pathways are shielded from viewers by one or more privacy structures. The method may include: displaying the count of selections by the individuals on a display device. The method may include: displaying at least one of: an overall count of selections by the individuals; a count of one or more issues; or video of individuals entering or exiting the plurality of physical pathways. The method may include: logically associating, by the at least one processor, the individual with a time that the individual passed through the physical pathway in a nontransitory computer memory. Each of the plurality of physical pathways includes an identifier that indicates with which of the first selectable options the physical pathway is associated. Implementations of the described techniques may include hardware, a method or process, or computer software on a computer-accessible medium.

One general aspect includes a method for implementing and tracking a decision-capturing process among individuals. The method also includes, for each choice of a plurality of choices, where each choice may include a plurality of selectable options, providing a corresponding plurality of physical pathways through which individuals may traverse, each of the plurality of physical pathways being associated with a different one of the plurality of selectable options of the choice. The method also includes, for each of the individuals, providing an instruction to the individual to physically pass through one of the plurality of physical pathways for each of the plurality of choices to select one of the plurality of selectable options for each of the plurality of choices. The method also includes detecting, by at least one processor, which physical pathway of the plurality of physical pathways that the individual passed through for each of the plurality of choices. The method also includes incrementing, by the at least one processor, a count of selections by the individuals for the selectable option of the selectable options that is associated with the detected physical pathway for each of the plurality of choices in a nontransitory computer memory. Other embodiments of this aspect include corresponding computer systems, apparatus, and computer programs recorded on one or more computer storage devices, each configured to perform the actions of the methods.

One general aspect includes a system to implement and track a decision-capturing process among individuals. The system also includes a plurality of physical pathways through which individuals may traverse, each of the plurality of pathways being associated with a selectable option of a corresponding plurality of selectable options. The system also includes control circuitry configured to: detect which of the physical pathways that individuals pass through; and responsive to detecting that an individual passed through a particular physical pathway, increment a count for the selectable option that is associated with the particular physical pathway in a nontransitory computer memory. Other embodiments of this aspect include corresponding computer systems, apparatus, and computer programs recorded on one or more computer storage devices, each configured to perform the actions of the methods.

Implementations may include one or more of the following features. The system where the control circuitry is configure to logically associate the individual with the selectable option that is associated with the physical pathway in a nontransitory computer memory. The control circuitry may include at least one detector including a machine-readable symbol reader, a camera, a mechanical detector, an electromagnetic signal detector, an optical signal detector, an acoustic signal detector, or a magnetic signal detector. Each of the plurality of physical pathways may include: a turnstile, a pair of spaced-apart sidewalls that define the physical pathway, a lane defined by or more lane indicators, other types of structures, or combinations thereof. The control circuitry may be configured to display the count for the selectable option on the display device. Implementations of the described techniques may include hardware, a method or process, or computer software on a computer-accessible medium.

### CLAUSES

1. A method for implementing and tracking a decision-capturing process among individuals, the method comprising:
for each selectable option of a plurality of first selectable options, providing a corresponding plurality of physical pathways through which individuals may traverse, each of the plurality of physical pathways being associated with a different one of the plurality of first selectable options; and
for each of the individuals,
   providing an instruction to the individual to physically pass through one of the plurality of physical pathways to select one of the plurality of first selectable options;
   detecting, by at least one processor, which physical pathway of the plurality of physical pathways that the individual passed through; and
   incrementing, by the at least one processor, a count of selections by the individuals for the selectable option of the first selectable options that is associated with the detected physical pathway in a nontransitory computer memory.
2. The method of clause 1, further comprising logically associating, by the at least one processor, the individual with the first selectable option that is associated with the detected physical pathway in a nontransitory computer memory.
3. The method of clause 1 wherein detecting which physical pathway of the plurality of physical pathways that the individual passed through comprises:
providing a plurality of machine-readable symbol readers, each of the plurality of machine-readable symbol readers physically positioned proximate a different one of the plurality of physical pathways and logically associated therewith; and
reading, by the one of the plurality of machine-readable symbol readers associated with the physical pathway that the individual passed through, a machine readable symbol carried by the individual.
4. The method of clause 1 wherein detecting which physical pathway of the plurality of physical pathways that the individual passed through comprises:
providing a plurality of signal detectors, each of the plurality of signal detectors physically positioned proximate a different one of the plurality of physical pathways and logically associated therewith; and
detecting a signal by the one of the plurality of signal detectors associated with the physical pathway that the individual passed through.
5. The method of clause 4 wherein each of the plurality of signal detectors comprises an electromagnetic signal detector, an optical signal detector, an acoustic signal detector, or a magnetic signal detector.
6. The method of clause 1 wherein each of the plurality of physical pathways comprises:
a turnstile;
a pair of spaced-apart sidewalls that define the physical pathway;
a doorway; or
a lane defined by or more lane indicators.
7. The method of clause 1 wherein at least some of the plurality of physical pathways are shielded from viewers by one or more privacy structures.
8. The method of clause 1, further comprising:
displaying the count of selections by the individuals on a display device.
9. The method of clause 1, further comprising:
displaying at least one of:
   an overall count of selections by the individuals;
   a count of one or more issues; or
   video of individuals entering or exiting the plurality of physical pathways.
10. The method of clause 1, further comprising:
logically associating, by the at least one processor, the individual with a time that the individual passed through the physical pathway in a nontransitory computer memory.
11. The method of clause 1, wherein each of the plurality of physical pathways includes an identifier that indicates with which of the first selectable options the physical pathway is associated.
12. A method for implementing and tracking a decision-capturing process among individuals, the method comprising:
for each choice of a plurality of choices, wherein each choice comprises a plurality of selectable options, providing a corresponding plurality of physical pathways through which individuals may traverse, each of the plurality of physical pathways being associated with a different one of the plurality of selectable options of the choice; and
for each of the individuals,
   providing an instruction to the individual to physically pass through one of the plurality of physical pathways for each of the plurality of choices to select one of the plurality of selectable options for each of the plurality of choices;
   detecting, by at least one processor, which physical pathway of the plurality of physical pathways that the individual passed through for each of the plurality of choices; and
   incrementing, by the at least one processor, a count of selections by the individuals for the selectable option of the selectable options that is associated with the detected physical pathway for each of the plurality of choices in a nontransitory computer memory.
13. A system to implement and track a decision-capturing process among individuals, the system comprising:
a plurality of physical pathways through which individuals may traverse, each of the plurality of pathways being associated with a selectable option of a corresponding plurality of selectable options; and
control circuitry configured to:
   detect which of the physical pathways that individuals pass through; and
   responsive to detecting that an individual passed through a particular physical pathway, increment a count for the selectable option that is associated with the particular physical pathway in a nontransitory computer memory.
14. The system of clause 13, wherein the control circuitry is configure to logically associate the individual with the selectable option that is associated with the physical pathway in a nontransitory computer memory.
15. The system of clause 13 wherein the control circuitry comprises at least one detector including a machine-readable symbol reader, a camera, a mechanical detector, an electromagnetic signal detector, an optical signal detector, an acoustic signal detector, or a magnetic signal detector.
16. The system of clause 13 wherein each of the plurality of physical pathways comprises:
a turnstile;
a pair of spaced-apart sidewalls that define the physical pathway; or
a lane defined by or more lane indicators.
17. The system of clause 13, further comprising:
a display device, wherein the control circuitry is configured to display the count for the selectable option on the display device.
18. The system of clause 13, wherein each of the plurality of physical pathways includes an identifier that indicates with which of the selectable options the physical pathway is associated.

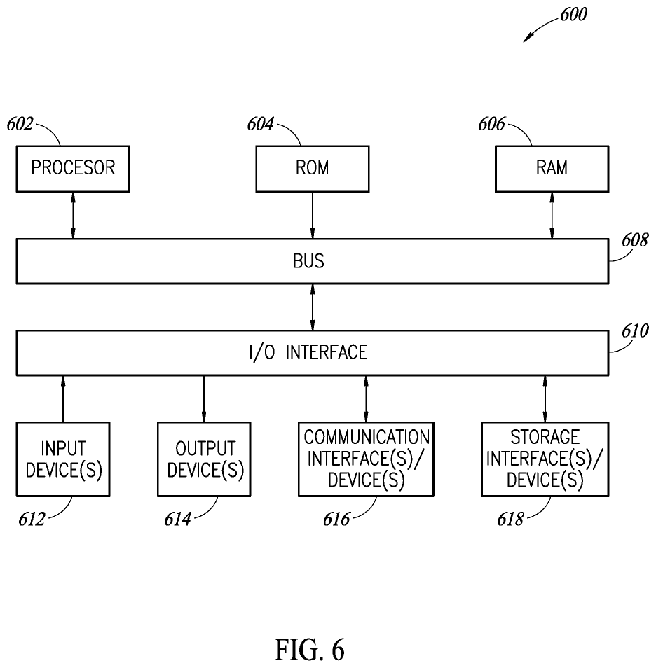

Referring to FIG. 6, a schematic structural diagram of a computer system 600 adapted to implement an electronic device of the embodiments of the present disclosure is shown. The electronic device shown in FIG. 6 is merely an example, and should not limit the function and scope of use of the embodiments of the present disclosure.

As shown in FIG. 6, the computer system 600 includes a processor 602, which may execute various appropriate actions and processes in accordance with a program stored in a read-only memory (ROM) 604 or a program loaded into a random access memory (RAM) 606 from a storage interface or device 618. The RAM 606 also stores various programs and data required by operations of the system 600. The processor 602, the ROM 604 and the RAM 606 are connected to each other through a bus 608. An input/output (I/O) interface 610 is also connected to the bus 608.

The following example components are connected to the I/O interface 610: one or more input devices 612, such as a keyboard, a mouse, or the like; one or more output devices 614, such as a liquid crystal display device (LCD) or other monitor, a speaker, or the like; one or more storage interfaces or devices 618, such as a magnetic disk, an optical disk, a magneto-optical disk, a semiconductor memory, or the like; and one or more communication devices 616, such as a network interface card, such as a LAN card and a modem. The communication device 616 performs communication processes via a network, such as the Internet.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program includes program codes for executing the method as illustrated in the flow chart. In such an embodiment, the computer program may be downloaded and installed from a network via the communication interface 616, and/or may be installed from the storage device 618. The computer program, when executed by the processor 602, implements the functions as defined by the methods of the present disclosure. It should be noted that the computer readable medium in the present disclosure may be computer readable signal medium or computer readable storage medium or any combination of the above two. An example of the computer readable storage medium may include, but is not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the present disclosure, the computer readable storage medium may be any tangible medium containing or storing programs which may be used by a command execution system, apparatus or element or incorporated thereto. In the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

A computer program code for executing operations in the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

In another aspect, the present disclosure further provides a computer-readable medium. The computer-readable storage medium may be included in the apparatus in the above described embodiments, or a stand-alone computer-readable medium not assembled into the apparatus. The computer-readable medium stores one or more programs.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

This application claims the benefit of priority to U.S. Provisional Application No. 63/252,015, filed Oct. 4, 2021, which application is hereby incorporated by reference in its entirety.

1. A method for implementing and tracking a decision-capturing process among individuals, the method comprising:
for each selectable option of a plurality of first selectable options, providing a corresponding plurality of physical pathways through which individuals may traverse, each of the plurality of physical pathways being associated with a different one of the plurality of first selectable options; and
for each of the individuals,
providing an instruction to the individual to physically pass through one of the plurality of physical pathways to select one of the plurality of first selectable options;
detecting, by at least one processor, which physical pathway of the plurality of physical pathways that the individual passed through; and
incrementing, by the at least one processor, a count of selections by the individuals for the selectable option of the first selectable options that is associated with the detected physical pathway in a nontransitory computer memory.
